(19) United States
(12) Patent Application Publication
(10) Pub. No.: US 2015/0142877 A1
(43) Pub. Date: May 21, 2015

(54) METHOD, SYSTEM, AND APPARATUS IN SUPPORT OF POTENTIAL FUTURE DELIVERY OF DIGITAL CONTENT OVER A NETWORK

(71) Applicant: KeepTree, Inc., New York, NY (US)

(72) Inventors: Hiroshi NAKATA, Yokohama-city (JP); Tadashi TOMIYAMA, Tokyo (JP); Masayoshi KIMURA, Tokyo (JP); Jonathan B. LOEW, Merrick, NY (US); Jennifer DRUBIN, New York, NY (US)

(21) Appl. No.: 14/541,272

(22) Filed: Nov. 14, 2014

Related U.S. Application Data
(63) Continuation-in-part of application No. 13/301,438, filed on Nov. 21, 2011.
(60) Provisional application No. 61/904,225, filed on Nov. 14, 2013.
(60) Provisional application No. 61/525,230, filed on Aug. 19, 2011.
(60) Provisional application No. 61/545,951, filed on Oct. 11, 2011.

(51) Int. Cl. H04L 29/08; H04L 29/06

(52) U.S. Cl. CPC H04L 67/22; H04L 67/42
USPC 709/203

(57) ABSTRACT

A method in support of potential future delivery of digital content items over a data network includes obtaining at a server over the data network at least one digital content item for potential future delivery and delivery metadata pertaining to potential future delivery of the digital content item. The delivery metadata includes at least one recipient and a monitoring interval. The digital content item is stored by a processor of the server, and, during the monitoring interval, a user account associated with the digital content item is monitored by the processor for an occurrence of an inactivity benchmark. Upon a lapse of the monitoring interval without an occurrence of the inactivity benchmark, the digital content item is delivered to the at least one recipient. A system can be constructed to implement the method described herein.

### CROSS-REFERENCE TO RELATED APPLICATIONS

This application claims the benefit of U.S. Provisional Patent Application No. 61/904,225, filed on Nov. 14, 2013, and is a Continuation-in-Part of U.S. patent application Ser. No. 13/301,438, filed, Nov. 21, 2011, which in turn claims the benefit of U.S. Provisional Patent Application No. 61/525,230, filed on Aug. 19, 2011, and U.S. Provisional Patent Application No. 61/545,951, filed on Oct. 11, 2011, all of which are incorporated in their entirety herein by reference.

### FIELD OF THE INVENTION

The present invention relates generally to Internet applications and social networks, and more specifically, to a system and method for archiving and potential future delivery of digital content over a network.

### BACKGROUND OF THE INVENTION

Various Internet applications allow users to send messages and multimedia digital content. For example, users can send texts and attached files, such as video or audio files, via email, or they may post content on their own dedicated space, thereby allowing permitted users to view the content, e.g., via a social network such as Facebook®. Other methods for communicating content include instant messaging, in which users can send and receive text and other content substantially in real time. For large multimedia content files, such as video files, users may upload content onto a server, and the content is made available to users over a website, e.g., YouTube®. Some communication services allow archiving of communications for future reference, either on a server for a limited time, or on the client device. In addition, although services exist for uploading content over a network and archiving it, such services are generally directed to allowing the user (and possibly social contacts of the user) the ability to access the content at any time of the user's choosing.

### SUMMARY OF EMBODIMENTS OF THE INVENTION

According to embodiments of the invention, there are provided a system and method for future delivery of digital content over a data network. Digital content may be obtained at a server over a data network from a client device or from a vendor server, the digital content being intended for future delivery to one or more recipients, on or after a designated delivery date. The delivery metadata may include at least one recipient and a delivery date. The digital content may be stored, and on the delivery date, be delivered to the at least one recipient.

According to embodiments of the invention, the stored digital content may be indexed based on delivery metadata. According to an embodiment of the invention, the digital content may be obtained by the server by interacting with a browser application operating on the client device so as to cause the client device to capture the digital content, for example, using a microphone and/or a camera. The server may cause the client device to transmit the digital content to the server. In some embodiments of the invention, the digital content may be a prerecorded file, which may be uploaded to the server. The server may play back the recorded content for approval prior to storing the content.

According to embodiments of the invention, the delivery date may be an absolute or relative date, or may be calculated based on data pertaining to another user. According to some embodiments of the invention, delivery may be performed by sending a recipient user a notification, e.g., via email or SMS text, that digital content from the recording user is available, at which time, the recipient user may log in to the server, and view or play back the digital content.

According to an embodiment of the invention, there are provided a system and method for future delivery may be obtained at least partially, from a third party vendor server, for example, upon purchase of the content by the sending user.

According to embodiments of the invention, method in support of potential future delivery of digital content items over a data network. Digital content items may be obtained at the server over the data network for potential future delivery to one or more recipients, along with delivery metadata pertaining to potential future delivery of the digital content item. The delivery metadata may include at least one recipient and a monitoring interval.

According to embodiments of the invention, the digital content item may be stored and, during the monitoring interval, a user account associated with the digital content item may be monitored by the processor for an occurrence of an inactivity benchmark. Upon a lapse of the monitoring interval without an occurrence of the inactivity benchmark, the digital content item may be delivered to the at least one recipient.

According to embodiments of the invention, upon the occurrence of the inactivity benchmark prior to the lapse of the monitoring interval, the processor can terminate the potential future delivery of the digital content item to the at least one recipient. According to further embodiments of the invention, upon the occurrence of the inactivity benchmark prior to the lapse of the monitoring interval, the processor can reset the monitoring interval and/or terminate the potential future delivery.

According to embodiments of the invention, the delivery metadata further includes at reset information and/or termination information related to the potential future delivery of the digital content item.

According to embodiments of the invention, monitoring the user account associated with the digital content item can further include assessing, by the processor, an inactivity period for the user account based on a non-occurrence of the inactivity benchmark from a start time of the monitoring interval until a given moment in time; and determining whether the inactivity period meets and/or exceeds the monitoring interval.

According to embodiments of the invention, the inactivity benchmark includes a login to the user account associated with the digital content item, and/or a receipt by the server of a status notification associated with the user account. The status notification can include a reply action responsive to a status update request delivered electronically to a designated recipient address associated with the user account.

According to embodiments of the invention, the monitoring interval includes a period beginning either at the time of selection of the monitoring interval or at a predefined future start time, and ending at a predefined future end time.

According to embodiments of the invention, the delivery metadata includes a plurality of recipients, each of the plurality of recipients having associated therewith a respective monitoring interval; and the potential future delivery of the digital content item to each of the plurality of recipients can be determined based on each respective monitoring interval. According to embodiments of the invention, the delivery metadata includes a recipient group having a plurality of recipients; and the potential future delivery of the digital content item to the recipient group can be determined based on the monitoring interval.

According to embodiments of the invention, the monitoring of the user account during the monitoring interval for the occurrence of the inactivity benchmark is either periodic monitoring or constant monitoring.

According to embodiments of the invention, the digital content item can be indexed based on the delivery metadata.

According to embodiments of the invention, obtaining the digital content item includes obtaining the digital content item over the data network from an originating client device by interacting with a browser application operating on the originating client device so as to cause the originating client device to capture and/or upload the digital content item to the server, and/or allow a file containing the digital content item to be uploaded to the server from the originating client device.

According to embodiments of the invention, delivering the digital content item to the at least one recipient includes sending to the at least one recipient a delivery notification, allowing the at least one recipient to connect to the server over the data network, and delivering the digital content item to the at least one recipient over the data network.

These and other aspects, features and advantages will be understood with reference to the following description of certain embodiments of the invention.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows a system including a server operating in accordance with embodiments of the invention;

FIG. 2 shows a schematic flow diagram showing a method of delivering content according to embodiments of the invention;

FIG. 3 shows a schematic flow diagram of interactions among the recording user, the future delivery server, the third party vendor, and a recipient, according to an embodiment of the invention; and

FIG. 4 shows a schematic flow diagram showing a method in support of potential future delivery of content according to embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Most current video sharing/messaging systems require either software installation (e.g., Skype®) or file uploading (e.g., Youtube®) in order to be utilized. For some potential consumers, these barriers may deter them from making use of the service. Software installation, for example, may take up valuable memory and slow down a computer, while the prospect of uploading files, regardless of its actual simplicity, may deter users who are less technologically savvy. According to embodiments of the invention, there may be provided a simple content delivery system, which need not require installing software or uploading large content files, but rather, may allow users to record directly to a server over a network, eliminating at least some of the above disadvantages.

There is furthermore a need for providing a system and method for allowing archiving and scheduled delivery of content, particularly from one user to another user. According to embodiments of the invention, users may be provided with the ability to create and record multimedia messages, which may be delivered in the future (e.g., months or years later) to friends and family, or even to the general public. In accordance with some embodiments of the invention, an archiving service may be provided to store content before and after the future delivery.

According to embodiments of the invention, users, e.g., parents and grandparents, may record greetings, advice and other messages for other users, e.g., their children and grandchildren, and schedule a future delivery, e.g., at a future date, or with reference to a future event or circumstance. According to some embodiments of the invention, the sending user may have content delivered in the future by a third party vendor, as discussed further below. A user may also schedule future delivery to the user himself, for example, as an archive of digital content, or online video journal for self-use later in life. A subscription model is also provided.

According to embodiments of the invention, newly created or uploaded digital content (or previously created or uploaded digital content) can be set for delivery to a recipient or group of recipients only if a specific trigger, preset by the user, is set off. If the trigger is not set off, the digital content will not be delivered to the recipients. According to some embodiments, the trigger can be based upon certain time intervals of non-activity in a user account, which the user may select from a pre-loaded list or dictate manually. For example, if a user (a) created a video; (b) selected recipients; and (c) selected “7 days” under this feature—the video would be sent to the pre-selected recipients if the user went 7 days without signing into their account.

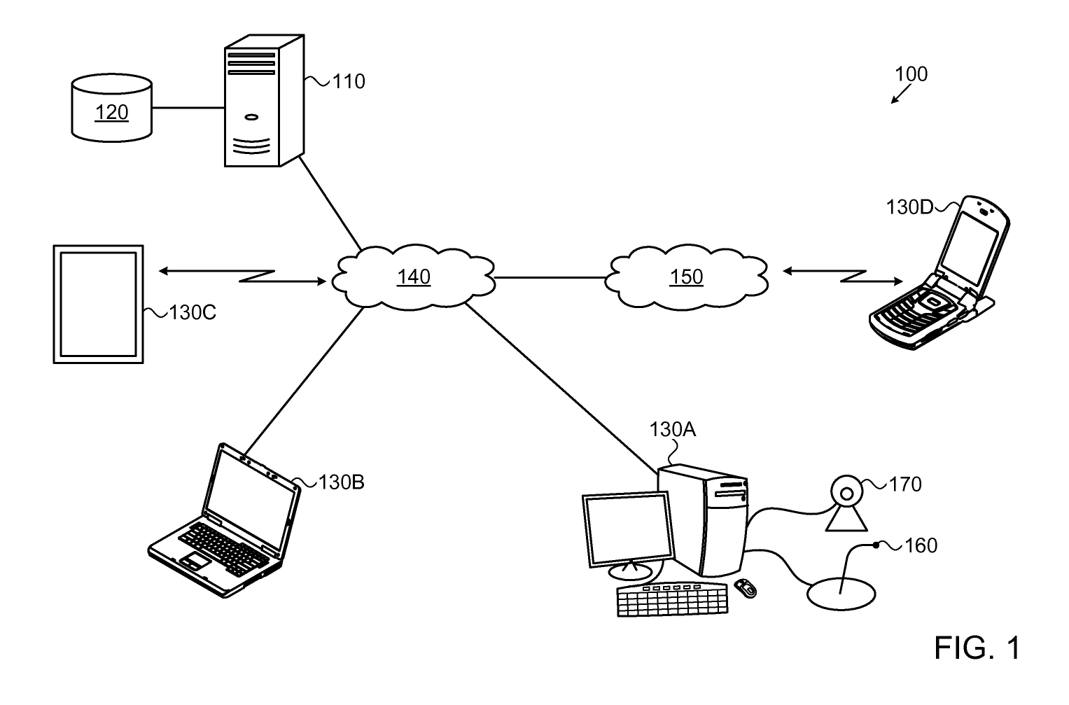

FIG. 1 shows a system 100 including a server 110 operating in accordance with embodiments of the invention. The server may allow users on remote client devices to connect over a network, such as the internet, and interact with the server, and to access content stored on storage 120, associated with server 110. It will be understood that server 110 may comprise a plurality of servers, or a cloud computing service. Storage 120 may be any suitable storage for storing multimedia content, and metadata associated therewith. It will be understood that server 110 and/or storage 120 may have indexing capabilities to allow rapid search and retrieval operations for multimedia content stored thereon.

Remote users may access server 110 over a data network 140 such as the internet, using any suitable client device, including desktop computer 130A, laptop computer 130B, tablet computer 130C, a mobile device such as smart phone 130D, etc. Some client devices, e.g., smart phone 130D may connect via more than one network, e.g., mobile telephone network 150 and data network 140. Some client devices, e.g., as used by recording users, may include integral or peripheral recording devices, e.g., a microphone 160 and/or a camera 170. Some client devices may typically include integral or peripheral playback devices, e.g., an audio speaker.

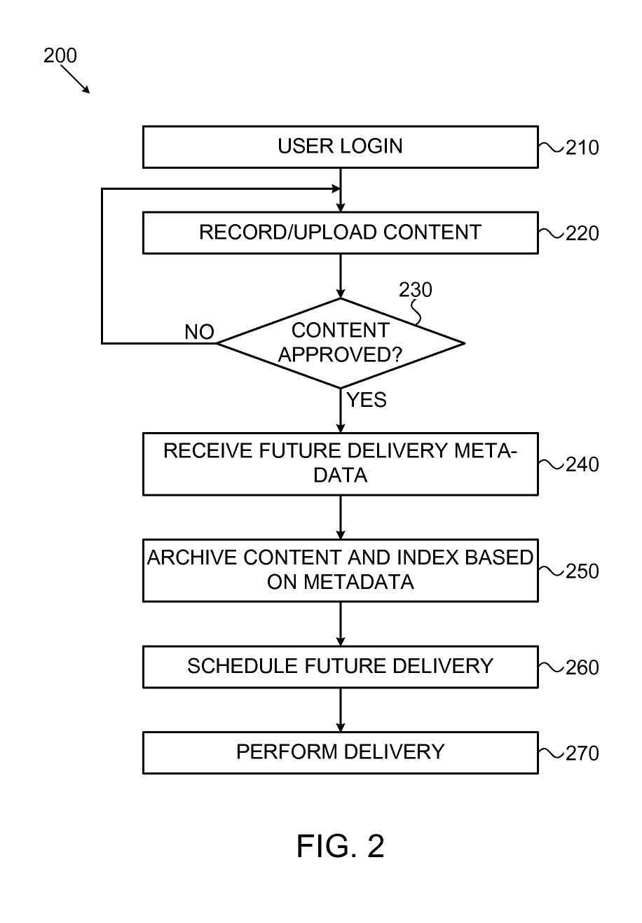

FIG. 2 is a schematic flow diagram showing a method 200 of delivering content according to embodiments of the invention. A recording user may log in (210) to the server, for example, by opening a website using a browser, and when asked, providing a username and password, which may be verified by the server. Upon being authenticated, the user may be provided with a number of options, including uploading or creating content for delivery, viewing delivered content, and managing scheduled content deliveries.

If the user selects uploading or creating content for delivery, the user may proceed to record and/or upload content (220) to the server. Prior to recording, the server may query the client device to ascertain which recording devices are available, and provide recording options for those devices. For example, if only a microphone is detected, the user may be prompted to provide an audio recording; if a microphone and a camera are both detected, the user may be prompted to provide an audiovisual recording, etc.

According to embodiments of the invention, the server may provide recording users with customized settings for specific events and usages, e.g., high school graduation, birthdays, the birth of a child, long distance care packages, and regular messaging. Optionally, there may be provided on the server's website tips for various greetings. Thus, for example, if the user is recording a birthday greeting, a tip may include suggestions such as mentioning the greeting user's experiences during that birthday, or possibly advice about the particular stage of life, e.g., teenage years, etc.

When the user is ready, the user may begin recording, at which time, the audio and video inputs may be captured until the user is finished. According to some embodiments of the invention, the content may be streamed directly to the server substantially as it is being recorded by the user in real time, thereby not requiring an application to be downloaded and operated on the client device. According to other embodiments of the invention, the content may be stored temporarily or buffered on the client device and uploaded to the server when recording is complete.

When the recording is complete, the user may be provided with the option of playing back the content to determine whether the user is satisfied with the content (230). If not, the user may re-record the content. If the user is satisfied, the content may be stored and the process may proceed. It will be understood that pre-recorded content (e.g., audiovisual file, photos, text or presentation documents, or other files) may simply be uploaded as a file in similar fashion.

The user may be prompted to provide, and the server may receive, metadata pertaining to the future delivery of the recorded content (240), including, for example, recipient(s), delivery date(s), subject, occasion, and a brief description of the content.

The recording user may be asked to provide one or more recipient users to whom the content should be delivered. The recording user may indicate a single recipient, e.g., a person celebrating a birthday, or a limited group of recipients, e.g., a group of family members, a group of classmates, etc. The recording user may also indicate that the content may be made available to any user with whom the recording user is registered as having a direct connection, e.g., on a contact tree, or even any user at all registered with the system.

A recipient may be a registered user, and may be among the recording user's contacts, or non-registered user. According to an embodiment of the invention, when a recording user creates content for a user who is not among their contacts, the server may attempt to search for the recipient by name, location, mutual contacts, and other information. If the recipient is not found, the server may open a placeholder or shadow record or profile for the non-registered user, including an email and other information provided by the recording user. The server may send the prospective user/recipient an email invitation to join the service and register to open a profile. In addition, when the recording user has completed recording the content, the server may send the prospective user/recipient an email notifying them that content has been recorded for them and inviting them to join the service and register to open a profile. If the recipient creates a profile, it may take the place of the placeholder or shadow profile, and have associated with it the content previously recorded.

According to embodiments of the invention, the recording user may register connections with other users, and may indicate a degree of connection, e.g., may specify a family relationship, or may simply create groups of family, etc. Users in a family group may be indicated by the system visually for a user, e.g., by an icon next to the user's username, indicating a family member. Thus, when a recording user records content, he may be given the option of sending it to individual users, to oneself, to one's entire contact tree, to one's entire family only, or to any member of the public.

The recording user may be prompted to provide the future date on which the content is to be provided. The date may be provided as a fixed date (e.g., Jun. 12, 2020), as a relative date (e.g., the first Monday in October 2020), or as a date based on an event in the recipient user's life (e.g., nephew Oscar's 17^{th} birthday). Various personal dates of recipients may be known, e.g., birthday, wedding anniversary, etc. Therefore, by simply indicating the particular recipient's 17^{th} birthday, the server may calculate the date by reference to the recipient's profile.

Other metadata about the recorded/uploaded content may be provided, for example, there may be provided a drop-down menu of occasions, e.g., Birthday, Anniversary, Graduation, etc. There may be provided a subject field, particularly for content including musings or advice on various topics, e.g., love, marriage, etc. There may also be provided a free-form text description in which the recording user may add a comment for the receiving user to view upon receiving the message. It will be understood that the content may be recorded and the metadata entered in any order within the bounds of the invention.

The recording user may also indicate privacy/publication preferences. For example, a recording user may prefer that certain content not be forwarded, or only be forwarded to users registered in the system as family. Some content may be labeled as public, in which case, when it becomes available, any user may search and view it. Public content may be indexed and searchable based on various metadata tags, e.g., recording user's name, subject of the content, recording user's country, recording date, etc. Recording users may further designate recorded content as intended for a certain identified collection of content contributions.

When the content is finalized, and the metadata received, the server may archive and index the content (250). The server may store the content, and optionally the metadata, on a long-term archive or storage resource. According to embodiments of the invention, the content may be stored and backed up in multiple physical locations, in order to provide additional security against loss of data.

A pointer to the content may be catalogued based on various indices, e.g., recording user, recipient user, recording date, delivery date, subject, occasion, description keywords. Such indexing enables Boolean searching for content, e.g., a grandfather user's message to a granddaughter user for her 10^{th} birthday, messages about business advice, etc. Another index includes, for example, a public/private checkbox. Thus, there may be created a video gallery, in which content created by recording users, who have permitted the video to be made publicly available, may also be searchable. Thus, for example, a person may search for child-rearing advice from other parents, who have recorded such content for their own children over the years.

It will be understood that recording users may be allowed to manage their scheduled deliveries, for example, to remove content that may no longer be relevant, re-record content, change delivery dates, etc. According to embodiments of the invention, the recording user may opt to notify or not to notify the recipient user before the digital content is made available, e.g., at the time the recording is made and stored, or a predefined time before the delivery is made, that the recording has been made, even though the content is not yet available. For example, a recipient user may be notified that a parent has recorded a birthday greeting, and that the digital content will be made available to the recipient user as of a particular date in the future. Some metadata, e.g., the text description, may be made available prior to the delivery date.

According to embodiments of the invention, the recording user may review, revise, and re-record content to be delivered prior to delivery. In cases where the recipient user is notified of the existence of the recorded content, the recording user may opt to notify or not to notify the recipient that revisions to the recorded content have been made.

A delivery date of the content may be determined or calculated, and delivery scheduled (260). When the time and/or date for delivery of the content arrives, the content may be delivered (270) to the appropriate recipient(s). A user may configure a profile or define a preferred means of notification, e.g., email, SMS message, etc. When a content message is ready for delivery, the recipients user(s) may be notified using the respective communication channel, and be encouraged to log in and view the content. Upon logging in, the recipient user may see a new message in his/her inbox, and upon selecting the message, may be displayed the text description and play back the recorded/uploaded content. According to some embodiments of the invention, recipient users who have not logged in and viewed delivered content may be sent one or more reminders. Recording users may be notified that their content has been played back to a recipient upon delivery.

According to an embodiment of the invention, at the recording user's option, the recipient user may be notified that content has been created at the time the content is created and stored, even though the content is not yet available. For example, the recipient may be notified that content has been recorded but is “locked” until a future date, and a thumbnail, e.g., a gray or shaded icon, may appear in their inbox, but with a “lock” icon superimposed on it, with a date listed as to when it will be released.

According to some embodiments of the invention, recipients may reply to the sending user, in which case, method 200 may be repeated for the recipient user to record a message, etc. Messages may also forward content to other users, for example, if permitted by the recording user based on privacy indications in the metadata, e.g., forward allowed only to users registered as family members.

According to embodiments of the invention, a user may order an item of content to be delivered to the recipient at the future date, for example, to be accompanied by a recorded greeting. Thus, for example, a parent may order a book, movie, music, or other third party content as a birthday gift for a child's future birthday, and record a greeting for the child explaining the significance of the gift. In some embodiments of the invention, the third party content may be digital content, and may be ordered over a network from a third-party vendor, e.g., Amazon.com®.

It will be understood that the above method steps and actions taken by the server may be implemented by executing a suitable computer program including instructions to be executed by the processor of the server to perform the steps. The instructions of the computer program may be stored on a non-volatile computer-readable memory, which may be accessed, interpreted, and executed by the processor of the server to perform the steps and actions described above.

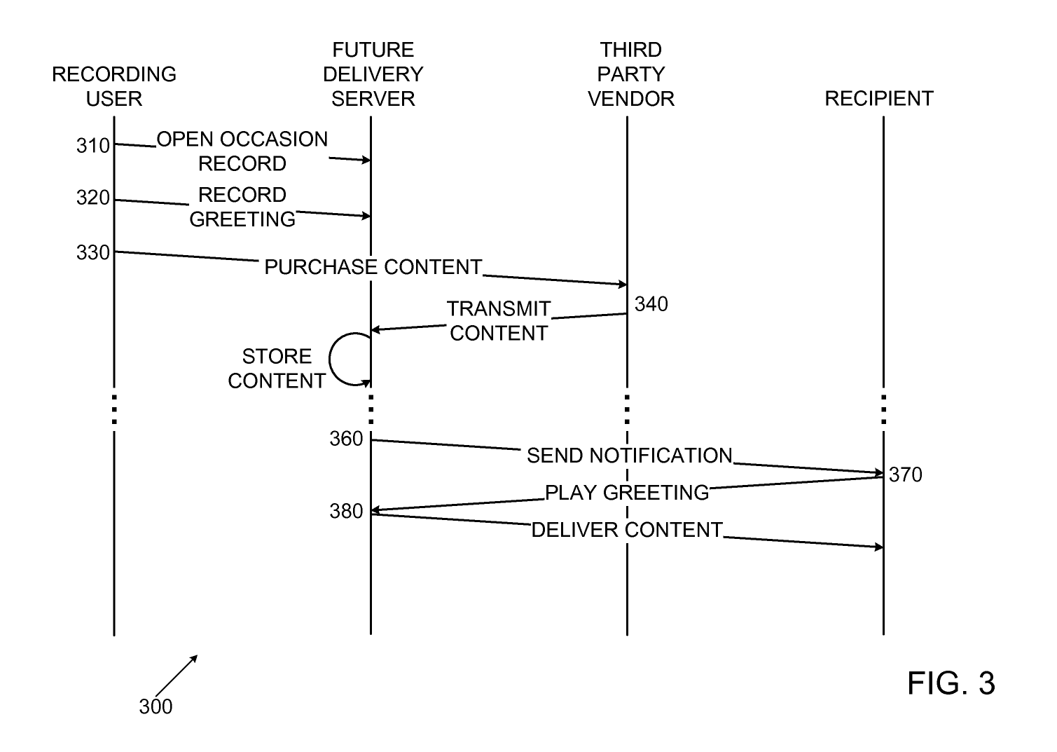

FIG. 3 shows a schematic flow diagram 300 of interactions among the recording user, the future delivery server, the third party vendor, and a recipient, according to an embodiment of the invention. For example, a recording user, e.g., a parent, may initiate an occasion record (310) with the future delivery server for an occasion, e.g., a child's 18^{th} birthday. The recording user may record a greeting (320), for example, substantially as described above.

The recording user may then log into a third party vendor, either directly, or via the future delivery server, and select and purchase a gift of digital content (330), e.g., an electronic book, music files, a movie, etc. At the checkout of the transaction with the third party vendor, the recording user may have the purchased content delivered to the future delivery server (340). This interaction between the third party server and the future delivery server may transpire in any of a number of different ways. For example, in some embodiments of the invention, this may be done by providing an email address registered with the future delivery server's domain name, and upon delivery, the future delivery server may notify the recording user and ask the recording user to identify the future occasion with which the purchase is associated. In other embodiments of the invention, the third party vendor server and the future delivery server may cooperate and communicate more closely to facilitate the future delivery. For example, the third party vendor may communicate with the future delivery server to ascertain the existence and identity of various open occasion records associated with the recording user. At checkout, the third party vendor may make available a “future gift” of “future delivery” option, in which instead of an email address or electronic device specified for delivery of the purchased content, the third party vendor may allow the purchaser to select an open occasion and associate the purchase with that occasion. The content will then be sent to the future delivery server and automatically be associated with the selected occasion.

The purchased content may be stored (350), for example, in association with other delivery data, e.g., the recorded greeting, and delivery metadata, as described above.

Upon delivery, the future delivery server may proceed substantially as described above. In an embodiment of the invention, a notification may be sent (360) that a recorded greeting has been made available, the recipient logs in and the recorded greeting is played back (370), and the stored third party content is delivered to the recipient (380).

According to embodiments of the invention, the server may provide additional functionality, for example, for various charges. For example, users may be given the option of requesting that certain selected content be emailed, downloaded, or burned onto a DVD and mailed to the user.

Additional features and personalization options may further augment the above basic system and method.

According to an embodiment of the invention, the server may provide reminders to users to send greetings. For example, a predetermined time, e.g., a week, before an approaching birthday, anniversary, holiday, e.g., Christmas, may trigger a reminder to users to send out greetings. It will be understood that reminders may be sent to registered users, as well as to prospective new users based on marketing lists.

In an embodiment of the invention, the system may maintain profiles of friends, family and other individuals associated with a recording user. The server may provide a recording user with reminders and recommendations for messages based on profiles of the user's friends, family and other individuals associated with the user. Thus, for example, if a recording user is registered as associated to another user, the server may provide a reminder to the recording user that the other user's birthday is approaching. The system may further provide suggestions as to digital content to be recorded based on the type of occasion, as described above. According to some embodiments of the invention, the advance time to various occasions may be personalized for each user, based on occasion, based on individuals being greeted, etc.

According to embodiments of the invention, the server may provide recording users with customized settings for specific events and usages, e.g., high school graduation, birthdays, the birth of a child, long distance care packages, and regular messaging.

According to embodiments of the invention, there may be a membership service, such that some services are provided for free, and others are provided based on payment of a charge.

According to an embodiment of the invention, on free portions of the web site, space may be sold to advertisers, which may desire to target users based on their registered profile, e.g., age, location, gender, etc. These advertisements may take the form of banner ads or short videos before or after recording content. Alternatively, or additionally, companies may sponsor fees for scheduled delivery of content and/or storage of such content, paying for the required fees. In some embodiments of the invention, an advertisement, e.g., from such a sponsor, may be shown as a banner, or played prior to or after the playback of the recorded content by the recipient.

According to an embodiment of the invention, first time users may be prompted to create a login ID and password, which may allow basic access and communication services free of charge. Thereafter, users may be charged, for example, per gigabyte of storage space, for the storage of digital content being stored for future delivery. According to an embodiment of the invention, storage periods shorter than a threshold period before the delivery date, e.g., one year, may be free of charge, but storage for longer than that threshold period before delivery may incur storage charges, which may be charged annually or in a lump sum up front. According to embodiments of the invention, if the recording user fails to pay a storage charge, another user, e.g., the recording user's family members, or the recipient of the particular recorded content may be notified that there is undelivered content associated with a non-paying user, and the other users may be prompted with an option to pay the storage charge until the delivery date. According to some embodiments of the invention, the server may obtain, e.g., upon registration, the recording user, and other users' telephone numbers, e.g., mobile phone numbers. A user may also indicate a preferred mode of telephone communication, e.g., voice message or SMS text. When a non-paying trigger is reached, e.g., a payment is 30 days overdue, the server may cause a communication, e.g., an automated voice message or SMS message, depending on the recording user's registered preference, to be delivered to the recording user's registered phone, notifying that recorded and undelivered content will be deleted if payment is not received. Such methods may also be used if an email address becomes obsolete, e.g., in the event of undeliverable mail to the registered email address. Other methods may be used to search for recipients in the event of non-payment, e.g., publication of advertisements in local newspapers listing owners of non-paying accounts with undelivered content, instructing interested recipients how to retrieve or re-activate such accounts.

According to some embodiments of the invention, content for which storage fees have not been paid may be deleted, or may become hidden from users for a grace period, e.g., one year, and may be retrieved upon payment of a retrieval fee.

According to embodiments of the invention, users may be given the option of downloading delivered content, or having the content burned onto a DVD, which may be provided at a fee.

The system of the present invention may be used for simple archiving of large content files. For such uses, users may be charged, for example, per gigabyte of storage space, for long-term archiving of videos that are sent and received if that storage is longer than the threshold period, e.g., one year. According to embodiments of the invention, if the recording user fails to pay a storage charge, another user, e.g., the recording user's family members, may be notified that there is archived content associated with a non-paying user, and the other users may be prompted with an option to pay the storage charge.

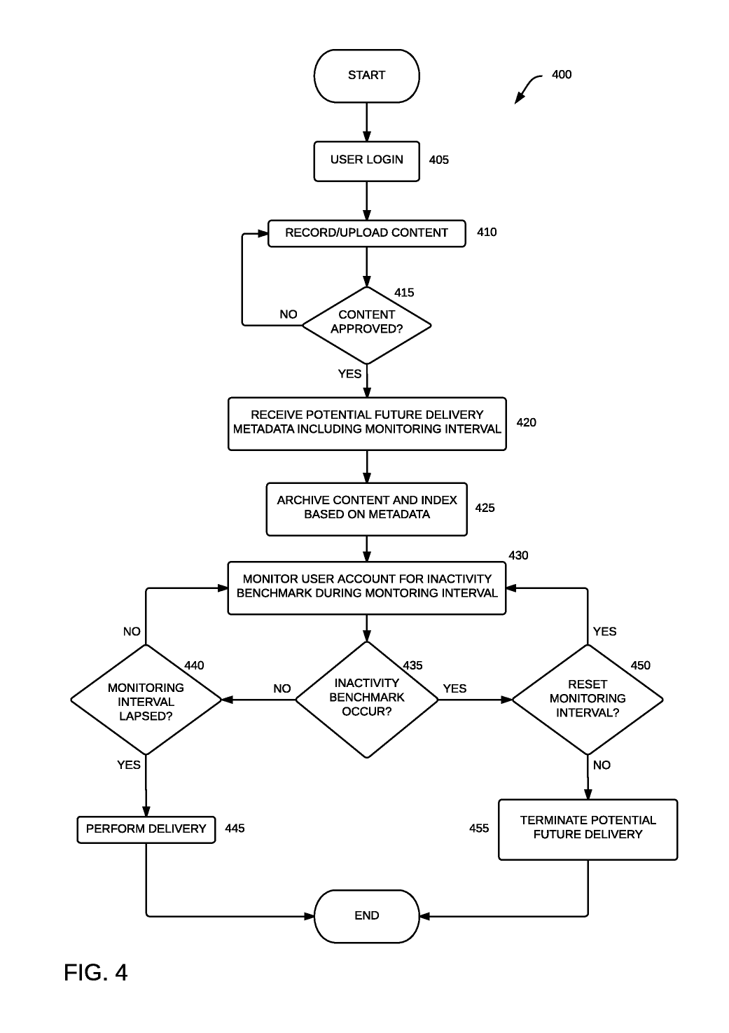

FIG. 4 shows a schematic flow diagram showing a method 400 in support of potential future delivery of content according to embodiments of the invention. A recording user may log in (405) to the server, for example, by opening a website using a browser, and when asked, providing a username and password, which may be verified by the server. Upon being authenticated, the user may be provided with a number of options, including uploading or creating content for delivery, viewing delivered content, and managing potential future content deliveries.

As in method 200, if the user selects uploading or creating content for delivery, the user may proceed to record and/or upload content (410) to the server. Prior to recording, the server may query the client device to ascertain which recording devices are available, and provide recording options for those devices. For example, if only a microphone is detected, the user may be prompted to provide an audio recording; if a microphone and a camera are both detected, the user may be prompted to provide an audiovisual recording, etc.

According to embodiments of the invention, when a user anticipates, for example, an unpredictable and/or potentially harmful or life threatening situation, they may use this feature to leave a “goodbye message” or pass along important confidential information in case they may not be able to. Some situations would include, for example, the user going into a dangerous surgery, the user going to a meeting with a dangerous person, the user being trapped in an emergency or disaster area, and the user fearing for life due to health issues.

Therefore, in some embodiments, the server may provide recording users with customized settings for specific events and usages, e.g., surgery, death, army recruitment, etc. Optionally, there may be provided on the server's website tips for various greetings. Thus, for example, if a user requiring a dangerous operation is recording a message relating to palliative care and end-of-life issues, a tip may include suggestions relating to Do-Not-Resuscitate (DNR) requests, burial arrangements, etc. When the user is ready, the user may begin recording (410) as described in detail in relation to FIG. 2. When the recording is complete, the user may be provided with the option of playing back the content to determine whether the user is satisfied with the content (415). If not, the user may re-record the content. If the user is satisfied, the content may be stored and the process may proceed. It will be understood that pre-recorded content (e.g., audiovisual file, photos, text or presentation documents, or other files) may simply be uploaded as a file in similar fashion, alternatively or in addition to presently recorded content. In some embodiments, when more than one content item is uploaded together, all items can be potentially delivered together as a package, such as, for example, an executed will.

The user may be prompted to provide, and the server may receive, metadata pertaining to the potential future delivery of the recorded content (420), including, for example, recipient(s), subject, occasion, a brief description of the content, and a monitoring interval, as explained herein.

The recording user may be asked to provide one or more recipient users to whom the content should be delivered. The recording user may indicate a single recipient, e.g., a family member, a personal lawyer, an agency or corporation (such as, for example, a healthcare institution or a local police department), etc., or a limited group of recipients, e.g., a group of family members, a group of business partners, etc. The recording user may also indicate that the content may be made available to any user with whom the recording user is registered as having a direct connection, e.g., on a contact tree, or even any user at all registered with the system.

As understood herein, a monitoring interval is the length of time that the system compares to an inactivity period to determine whether or not to take action and deliver a video to the selected recipient(s). In some embodiments, a user may select pre-set options created by the system, including without limitation options such as 7, 14, 30, or 60 days, or the user may be given the option to manually select an interval of any number of days or hours based on their preference.

In some embodiments, as soon as the inactivity period meets and/or exceeds the monitoring interval, the video will be delivered to the selected recipient(s). According to some embodiments, the inactivity period is determined by measuring the length of time from either (a) the time and/or date that the monitoring interval is selected, or (b) the time and/or date of the most recent occurrence of an inactivity benchmark as described herein to the current time and/or date.

As understood herein, an inactivity benchmark is a benchmark action, the occurrence or non-occurrence of which the system uses to determine the end of the inactivity period. For example, in some embodiments the inactivity benchmark is a user logging into their account, and the inactivity period would be measured by how long it has been since the user last logged into their account (or by whether the user has logged into their account at all since monitoring interval began). In other embodiments, the inactivity benchmark can be a receipt by the server of a status notification associated with the user account. For example, the status notification can be a reply action responsive to a status update request delivered electronically to a designated recipient address associated with the user account. A reply action can be a reply e-mail, an indication that the user read the status update request, or any indication that the user performed an action responsive to the status update request, e.g., clicking on an embedding link or virtual button with the reply request, etc. In some embodiments, the inactivity benchmark can be a benchmark action performed on a third-party website or application associated with the user account, via, e.g., an application programming interface (API). For example, the system can be configured such that logging into a third-party e-mail application or posting a social media status update (e.g., a Facebook® post or Twitter® “tweet”) from a third-party social media platform can serve as a status notification for the server.

In accordance with some embodiments of the invention, users can be provided with repeatability options, the selections of which can be received as part of the metadata. For example, users can be given the option to selection either a single occurrence monitoring interval or a resetting monitoring interval, to determine how the inactivity period is measured. If the system is set to reset, then upon the occurrence of the inactivity benchmark, the inactivity period resets and the system then measures the length of time, for example, by comparing the current date and time to the date and time of the last occurring inactivity benchmark. If the system is set to single occurrence, then upon the occurrence of the inactivity benchmark the inactivity period expires and does not reset, and the process is terminated by the server. The practical effect of this is that the digital content item is not automatically delivered and is no longer governed by the process unless it is manually reset for a subsequent period.

In accordance with some embodiments, when there are multiple recipients selected, each recipient selection can be customized with their own monitoring interval, inactivity period, inactivity benchmark, and repeatability settings. Alternatively, multiple recipients can be associated with a recipient group, and delivery to all members of the recipient group can be governed by a single customization. When delivery instructions are changed for the group, the change would apply to each member of the group. Similarly, multiple recipient groups can either have their own customizations or a single customization, for example, as a default setting. In some embodiments, customization options and features can be provided to users in a settings tab of a video that already exists within their user accounts, or within their delivery settings after recording or uploading a video to their user account.

Regarding customization of multiple recipients with different delivery instructions, in some embodiments the system can be configured to store and periodically search metadata for a digital content item and user accounts associated with the digital content item to determine the proper instructions for each recipient. If different instructions were applied to different recipients, the system can read those in the metadata and adjust accordingly.

When the content is finalized, and the metadata received, the server may archive and index the content (425). The server may store the content, and optionally the metadata, on a long-term archive or storage resource. According to embodiments of the invention, the content may be stored and backed up in multiple physical locations, in order to provide additional security against loss of data.

As in method 200, a pointer to the content may be catalogued based on various indices, e.g., recording user, recipient user, recording date, monitoring interval, subject, occasion, description keywords, content type, etc. Such indexing enables Boolean searching for content, e.g., a husband user's message to a wife user regarding his enrollment in the army, messages about healthcare instructions, etc. Another index includes, for example, a public/private checkbox. Thus, there may be created a video gallery, in which content created by recording users, who have permitted the video to be made publicly available, may also be searchable. Thus, for example, a person may search for health advice from others who have recorded such content for their own circumstances over the years.

It will be understood that recording users may be allowed to manage their scheduled deliveries, for example, to remove content that may no longer be relevant, re-record content, change delivery dates, etc. According to embodiments of the invention, the recording user may opt to notify or not to notify the recipient user before the digital content is made available, e.g., at the time the recording is made and stored, or a predefined time before the delivery is made, that the recording has been made, even though the content is not yet available. For example, a recipient user may be notified that a parent has recorded a will, and that the digital content will be made available to the recipient user upon the death of the parent. Some metadata, e.g., a text description, content type, or a content ID, may be made available prior to the delivery date.

In accordance with embodiments of the invention, once the monitoring interval begins at the predetermined time (430), the system is configured to begin assessing the inactivity period for the user account for the occurrence of an inactivity benchmark. It will be readily understood that in various embodiments there may be more than one predefined inactivity benchmark, and therefore the system can be configured to monitor for the occurrence of any, all, or only particular one or ones, etc. Monitoring to determine whether an inactivity benchmark has occurred (435) can be performed on a periodic basis, e.g., hourly or daily, or on a constant basis.

In accordance with some embodiments, the assessment of the inactivity period is based on the non-occurrence of the inactivity benchmark from a start time of the monitoring interval until a given moment in time, for example, three weeks after start time. The system can then determine whether the inactivity period meets and/or exceeds the monitoring interval, and whether the monitoring interval has lapse (440). Provided the monitoring interval has not yet lapsed and there have been no occurrences of an inactivity benchmark, the system will continue to monitor the account.

For example, in some embodiments, the monitoring interval selected or inputted can be stored in the metadata of the specific digital content item. Date and time of the inactivity benchmark (e.g., the last log-in) can be stored in the metadata of the user account. The system may periodically search the metadata of both digital content items and user accounts associated with them for any interval that may have been selected/inputted by a user and the start time of the monitoring interval, comparing the two to determine whether or not the digital content item be sent out. If the difference between the current date and time and the start of the inactivity period is equal to or longer than the monitoring interval, the digital content item will be automatically delivered to the selected recipient(s) (445). If the difference between the current date and time and the start of the inactivity period is shorter than the monitoring interval (e.g., the monitoring interval has not yet lapsed), the system will take no action other than to continue monitoring.

In some embodiments, when an inactivity benchmark occurs (e.g., is detected by the system during the monitoring process) prior to the lapsing of the monitoring interval, the system may take one of a number of actions depending on the configuration of repeatability options which can be provided to the user at the time of setup and included in the delivery metadata. As described herein, in some embodiments users can be provided the option to select a reset instruction (450). If a user selects the reset option, then upon each occurrence of the inactivity benchmark, the inactivity period can be reset and, from that point, be measured by the most recent occurrence of the inactivity benchmark. Prior to the first occurrence of the inactivity benchmark, the inactivity period could be measured, for example, from the date and time of the set-up of the inactivity monitoring process or from a predefined start time (e.g., data and time). Subsequent to the first occurrence of the inactivity benchmark, the inactivity period could then be measured from the most recent occurrence of the inactivity benchmark. Furthermore, users can be given the option to select a finite number of resets, after which no more resets would be performed.

In some embodiments, if a user selects a single occurrence option, then once the inactivity benchmark occurs, the delivery of the digital content item would no longer be governed by this process (455) Likewise, if the user selected a finite number of resets, then the last reset would function as a single occurrence option. In either embodiment, once there is an inactivity benchmark occurrence and no reset options, the system would terminate the potential future delivery process (455) and the method ends.

In accordance with embodiments of the invention, under either the reset or single occurrence settings, if monitoring interval settings are changed, then the entire process can be configured to reset, and the date and time of the change of the monitoring interval settings would be treated as if it were the date and time of the set-up of the process.

In accordance with various embodiments of the invention, users can be given the ability configure instructions that are universal to all videos in their user account to which they want to apply governance of the potential future delivery system over their delivery. Monitoring interval, inactivity benchmark, and repeatability settings could be set by the user under their account settings. The user could then be provided with the ability to simply choose to include any video(s) of their choosing in the configuration, either during the record/upload process or after the video has already been placed in their user account. In some embodiments, all videos that are selected as governed by (or part of) the customization would be governed by the universal interval, inactivity benchmark, and repeatability settings. The system would act upon those videos as described herein for a sing digital content item using the universal instructions.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method in support of potential future delivery of digital content over a data network, performed on a server having a processor, memory, and one or more instructions stored in the memory and executing in the processor, the method comprising:
obtaining at the server over the data network at least one digital content item for potential future delivery and delivery metadata pertaining to potential future delivery of the digital content item, wherein the delivery metadata includes at least one recipient and a monitoring interval;
storing, by the processor, the digital content item and the monitoring interval;
during the monitoring interval, monitoring, by the processor, a user account associated with the digital content item for an occurrence of an inactivity benchmark; and
upon a lapse of the monitoring interval without an occurrence of the inactivity benchmark, delivering the digital content item to the at least one recipient.

2. The method as in claim 1, further comprising:
upon the occurrence of the inactivity benchmark prior to the lapse of the monitoring interval, terminating, by the processor, the potential future delivery of the digital content item to the at least one recipient.

3. The method as in claim 1, further comprising:
upon the occurrence of the inactivity benchmark prior to the lapse of the monitoring interval, one of resetting, by the processor, the monitoring interval, and terminating, by the processor, the potential future delivery;
wherein the delivery metadata further includes at least one of reset information and termination information related to the potential future delivery of the digital content item.

4. The method as in claim 1, wherein monitoring the user account associated with the digital content item further comprises:
assessing, by the processor, an inactivity period for the user account based on a non-occurrence of the inactivity benchmark from a start time of the monitoring interval until a given moment in time; and
determining whether the inactivity period one of meets and exceeds the monitoring interval.

5. The method as in claim 1, wherein the inactivity benchmark comprises at least one of a login to the user account associated with the digital content item, and a receipt by the server of a status notification associated with the user account.

6. The method as in claim 5, wherein the status notification comprises a reply action responsive to a status update request delivered electronically to a designated recipient address associated with the user account.

7. The method as in claim 1, wherein the monitoring interval comprises a period beginning at one of the time of selection of the monitoring interval and at a predefined future start time, and ending at a predefined future end time.

8. The method as in claim 1, wherein the delivery metadata includes a plurality of recipients, each of the plurality of recipients having associated therewith a respective monitoring interval; and
wherein the potential future delivery of the digital content item to each of the plurality of recipients is determined based on each respective monitoring interval.

9. The method as in claim 1, wherein the delivery metadata includes a recipient group comprising a plurality of recipients; and
wherein the potential future delivery of the digital content item to the recipient group is determined based on the monitoring interval.

10. The method as in claim 1, wherein the monitoring of the user account during the monitoring interval for the occurrence of the inactivity benchmark is one of periodic monitoring and constant monitoring.

11. The method as in claim 1, further comprising indexing the digital content item based on the delivery metadata.

12. The method as in claim 1, wherein obtaining the digital content item comprises:
obtaining the digital content item over the data network from an originating client device by interacting with a browser application operating on the originating client device so as to one of cause the originating client device to capture and upload the digital content item to the server, and allow a file containing the digital content item to be uploaded to the server from the originating client device.

13. The method as in claim 1, wherein delivering the digital content item to the at least one recipient comprises:
sending to the at least one recipient a delivery notification;
allowing the at least one recipient to connect to the server over the data network; and
delivering the digital content item to the at least one recipient over the data network.

14. A system in support of potential future delivery of digital content items over a data network, comprising:
a server having a processor and memory, and being connected to the data network;
one or more instructions stored in the memory and executable in the processor, which, when executed, configure the processor to:
obtain over the data network at least one digital content item for potential future delivery and delivery metadata pertaining to potential future delivery of the digital content item, wherein the delivery metadata includes at least one recipient and a monitoring interval;
store the digital content item and the monitoring interval;
during the monitoring interval, monitor a user account associated with the digital content item for an occurrence of an inactivity benchmark; and
upon a lapse of the monitoring interval without an occurrence of the inactivity benchmark, deliver the digital content item to the at least one recipient.

15. The system as in claim 14, wherein upon the occurrence of the inactivity benchmark prior to the lapse of the monitoring interval, the processor is further configured to terminate the potential future delivery of the digital content item to the at least one recipient.

16. The system as in claim 14, wherein upon the occurrence of the inactivity benchmark prior to the lapse of the monitoring interval, the processor is further configured to one of reset the monitoring interval, and terminate the potential future delivery; and
wherein the delivery metadata further includes at least one of reset information and termination information related to the potential future delivery of the digital content item.

17. The system as in claim 14, further configured to:
assess an inactivity period for the user account based on a non-occurrence of the inactivity benchmark from a start time of the monitoring interval until a given moment in time; and
determine whether the inactivity period one of meets and exceeds the monitoring interval.

18. The system as in claim 1, wherein the inactivity benchmark comprises at least one of a login to the user account associated with the digital content item, and a receipt by the server of a status notification associated with the user account.

19. The system as in claim 18, wherein the status notification comprises a reply action responsive to a status update request delivered electronically to a designated recipient address associated with the user account.

20. The system as in claim 14, wherein the monitoring interval comprises a period beginning at one of the time of selection of the monitoring interval and at a predefined future start time, and ending at a predefined future end time.

21. The system as in claim 14, wherein the delivery metadata includes a plurality of recipients, each of the plurality of recipients having associated therewith a respective monitoring interval; and
wherein the potential future delivery of the digital content item to each of the plurality of recipients is determined based on each respective monitoring interval.

22. The system as in claim 14, wherein the delivery metadata includes a recipient group comprising a plurality of recipients; and
wherein the potential future delivery of the digital content item to the recipient group is determined based on the monitoring interval.

23. The system as in claim 14, wherein the processor is further configured to monitor the user account during the monitoring interval for the occurrence of the inactivity benchmark one of periodically and constantly.

24. The system as in claim 14, further configured to index the digital content item based on the delivery metadata.

25. The system as in claim 14, further configured to:
obtain the digital content item over a data network from an originating client device by interacting with a browser application operating on the originating client device so as to one of cause the originating client device to capture and upload the digital content item to the server, and allow a file containing the digital content item to be uploaded to the server from the originating client device.

26. The system as in claim 14, further configured to:
send to the at least one recipient a delivery notification;
allow the at least one recipient to connect to the server over the data network; and
deliver the digital content item to the at least one recipient over the data network.
